(19) United States
(12) Patent Application Publication
(10) Pub. No.: US 2007/0177144 A1
(43) Pub. Date: Aug. 2, 2007

(54) Weathering test apparatus with spectroradiometer and portable spectroradiometer

(75) Inventors: Toshikazu Hasegawa, Tokyo (JP); Yukihiro Hirashita, Tokyo (JP); Takayuki Honda, Tokyo (JP)

Correspondence Address: OSHA LIANG L.L.P., 1221 MCKINNEY STREET, SUITE 2800, HOUSTON, TX, 77010, US

(73) Assignee: EKO INSTRUMENTS CO., LTD., Tokyo (JP)

(21) Appl. No.: 11/341,887

(22) Filed: Jan. 27, 2006

(51) Int. Cl. G01J 3/28

(52) U.S. Cl. 356/328; 73/865.6

(57) ABSTRACT

The present invention provides a weathering test apparatus system capable of accurately monitoring deterioration of a light source used in a weathering test apparatus. According to the present invention, there is provided a weathering test apparatus system, which comprises a weathering test apparatus with a light source and a spectroradiometer which monitors deterioration of the light source, wherein the spectroradiometer comprises an entrance window which captures light from the light source, and a spectroscopic unit which is connected optically to the entrance window and has a multi-wavelength resolution function, the spectrometer being disposed inside the weathering test apparatus.

### BACKGROUND OF THE INVENTION

1. Field of the Invention

The present invention relates to a spectroradiometer for measuring the spectroscopic characteristics of a light source for use in a weathering test apparatus.

2. Description of the Related Art

Generally, a weathering test apparatus is a device for forcibly emitting radiation, such as ultraviolet radiation, to various materials, substances, products and the like (hereinafter generically referred to as “material to be tested”) to evaluate weather resistance and the like according to the degree of deterioration of the material over time (see, for example, Japanese Patent Application Laid-Open No. 2001-208675).

FIG. 1 shows a schematic cross-sectional view of an example of a weathering test apparatus in a conventional technology. As shown in FIG. 1, the weathering test apparatus 10 comprises, in a constant-temperature bath 20, a weathering test light source 30 and a basket 40 on which a material to be tested is placed rotatably. As the weathering test light source 30, the one which has an intense emission band in an ultraviolet region such as a xenon lamp or an iodine lamp is mainly used. Here, “material to be tested 50” is a polymer material, a building material such as ceramic, or a painted metal board.

Although the material to be tested 50 becomes deteriorated due to radiation from the light source, and deterioration is then accelerated, thus the constant-temperature bath 20 is kept under high temperature and high humidity. In order to evaluate the degree of deterioration of the material to be tested 50 , it is necessary to monitor the amount of exposure light from the light source 30, and for the purpose of which the weathering test apparatus is provided with a light quantity detector. In order to monitor the light source, the apparatus comprises therein a light source monitor 60. This light source monitor 60 is a light quantity detector in which normally a single silicon diode and an optical filter are combined.

FIG. 2 shows a schematic view showing spectral sensitivity of the light quantity detector which is used in the weathering test apparatus of the conventional technology. As shown in FIG. 2, with the light quantity detector in the conventional technology, it is possible to observe the amount of the light source in a region near approximately a single wavelength (for example, approximately 10 nm) in a shadow zone only. This light quantity detector has sensitivity only in a single wavelength band or a specific wavelength band. Therefore, although the light quantity detector was able to monitor reduction of the amount of the light source or reduction of the amount of light in the specific wavelength band, it could not detect reduction of the amount of light in a plurality of wavelength bands.

On the other hand, the spectroradiometer, which is the light quantity detector, was conventionally disposed outside the weathering test apparatus, and the light source inside the weathering test apparatus was measured non-contiguously through a window of the weathering test apparatus. However, since measurement was carried out through the window, data regarding the amount of spectral radiance entering a surface of the material to be tested could not be obtained accurately.

Further, deterioration of an organic material occurs mostly due to a combined exposure to radiation of various wavelengths and ultraviolet wavelength. However, the conventional light quantity detector could not detect amount of light with a plurality of wavelengths, and thus could not evaluate deterioration accurately.

Here, it is known that the mechanism of deterioration of the material to be tested can be obtained as the product of spectral intensity of a light source and a reaction curve with respect to a wavelength of the material to be tested. Therefore, information on, not a single wavelength, but spectral radiation of the light source is required in a deterioration test of, for example, a polymer material with various reaction curves. It takes a long period of time to have an exposure test, and furthermore spectral radiation itself of the light source changes due to deterioration depending on the wavelength, thus the exposure test needs to be monitored.

### SUMMARY OF THE INVENTION

In view of the above problems, a first object of the present invention, therefore, is to provide a weathering test apparatus system in which deterioration of the light source for use in the weathering test apparatus can be monitored precisely.

In addition, a spectroradiometer capable of readily measuring light quantity outside has been desired recently. Therefore, a second object of the present invention is to provide a portable spectroradiometer which is easy to use and can respond to various incidence angles.

Most of the materials to be tested are used under the natural light outside, thus the original purpose of a weathering test is to estimate a state of exposure outside based on test results. Since the wavelength characteristic of the light source of the weathering test apparatus is different from the wavelength characteristic of the natural light, information on spectral radiation of the both light source and natural light is essential in application of the test result obtained from the weathering test apparatus to the natural light. Moreover, the wavelength characteristic of the natural light changes significantly by atmospheric conditions, thus it needs to be measured frequently. For this reason, a portable and easy-to-use spectroradiometer is required.

As a result of an extensive research regarding the weathering test apparatus, the inventors have completed the present invention by combining the weathering test apparatus and an array photodetector. In other words, the first aspect of the present invention provides a weathering test apparatus system, comprising: a weathering test apparatus with a light source; and a spectroradiometer which monitors deterioration of the light source, wherein the spectroradiometer comprises an entrance window which captures light from the light source, and a spectroscopic unit which is connected optically to the entrance window and has a multi-wavelength resolution function, and the spectroradiometer is disposed inside the weathering test apparatus. By employing such configuration, quantity of light with a plurality of wavelengths can be monitored accurately and simultaneously with the weathering test, and deterioration of the light source of the weathering test apparatus can be detected accurately.

According to a preferred embodiment of the present invention, the spectroscopic unit comprises a photodiode array.

According to a preferred embodiment of the present invention, in this system, the spectroradiometer has a heat-insulated and hermetically-sealed structure so as to be able to withstand a high temperature and a high humidity. By providing such heat-insulated and hermetically-sealed structure, durability of the spectrometer for monitoring deterioration of the light source for exposure testing can be improved.

According to a preferred embodiment of the present invention, in this system, the spectroradiometer is battery-powered and further comprises a memory which can record therein measured spectral radiation data. By providing such batter-powered portion and a recording portion, miniaturization of the spectroradiometer can be realized, thus the spectroradiometer functions as a portable spectral radiometer.

Moreover, the second aspect of the present invention provides a portable spectroradiometer, comprising an entrance window which captures light from the light source, and a spectroscopic unit which is connected optically to the entrance window and has a multi-wavelength resolution function, wherein the entrance window of the spectroradiometer is replaceable. By employing such configuration, the entrance window capable of responding to various incidence angles can be made replaceable, whereby the portable spectroradiometer which can be used for various purposes can be realized.

According to a preferred embodiment of the present invention, in the portable spectrometer, the spectroscopic unit comprises a photodiode array.

According to a preferred embodiment of the present invention, in the portable spectrometer, the spectroradiometer has a heat-insulated and hermetically-sealed structure so as to be able to withstand a high temperature and a high humidity.

According to a preferred embodiment of the present invention, in the portable spectrometer, the spectroradiometer is battery-powered and further comprises memory which can record therein measured spectral radiation data. Such portable spectroradiometer can be used for various purposes outside.

It should be noted that the term “a high temperature and a high humidity” used in the present invention means that the ambient temperature is not less than 40° C. and the humidity is from 85 to 100%.

According to the present invention, since the light source of the weathering test apparatus and the photodiode array having the multi-wavelength resolution function are provided in one system, deterioration of the light source of the weathering test apparatus can be monitored precisely. More specifically, deterioration of the light source can be measured simultaneously and extensively for a specific wavelength of the light source of the weathering test apparatus, or wavelength regions ranging from a narrow wavelength region such as a bright line to a wide wavelength region.

Furthermore, since the conventional weathering test apparatus was unable to accurately grasp the relationship between a deterioration condition of the material to be tested and irradiating light from the light source, thus the conventional weathering test apparatus was insufficient in terms of clarification of the deterioration mechanism. In addition, the materials to be tested are used for the purpose of eventually estimating deterioration thereof in the open air (outside), but since the spectroscopic characteristics of the natural light and the light source of the weathering test apparatus are different, the conventional method had difficulty in accurately grasping the relationship between the deterioration condition and the irradiating light. The present invention can resolve such difficulty and contribute to the clarification of the deterioration mechanism by means of the relationship between deterioration of the material to be tested and the light source of the weathering test apparatus.

Moreover, deterioration conditions in the open air (outside) can be estimated based on a result obtained from the weathering test apparatus.

### BRIEF DESCRIPTION OF THE DRAWINGS

Other objects, features and advantages of the present invention will become more apparent from the following detailed description when read in conjunction with the accompanying drawings, in which:

FIG. 1 shows a schematic cross-sectional view of an example of the weathering test apparatus in the prior art, where it should be noted that the arrows in the figure show flows of air, and a reference numeral 70 indicates a a light source monitor;

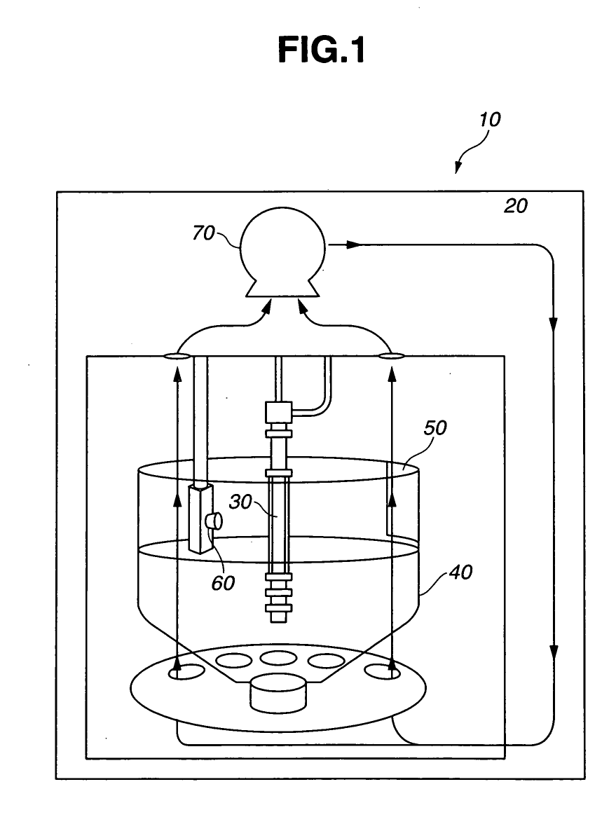

FIG. 2 shows a schematic view showing spectral sensitivity of the light quantity detector for use in the weathering test apparatus of the prior art;

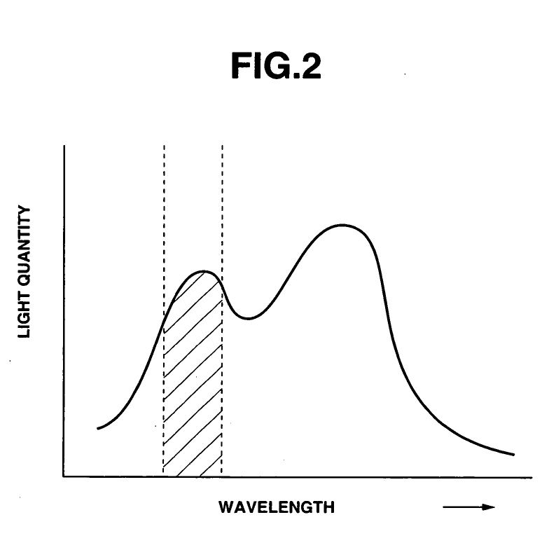

FIG. 3 shows a schematic cross-sectional view of the weathering test apparatus system according to the first aspect of the present invention, in which the weathering test apparatus and the spectroradiometer have the multi-wavelength resolution function for the weathering test apparatus;

FIG. 4 shows a schematic functional block diagram of an internal structure of the spectroradiometer for use in the present invention;

FIG. 5 shows a schematic front view of the portable spectroradiometer which is not limited in the use of the weathering test apparatus and can be used for various purposes, according to the second aspect of the present invention; and

FIGS. 6A, 6B sand 6C shows a drawing illustrating an embodiment of the entrance window which is replaceable with respect to the portable spectroradiometer for use in the second aspect of the present invention. 10: weathering test apparatus; 20, 180: constant-temperature bath; 30, 120: weathering test light source; 40, 140: basket; 50: material to be tested; 60: light source monitor; 70: a light source monitor; 100: weathering test apparatus system; 160: spectroradiometer; 165, 320: entrance window; 170: flexible fiber; 175: shutter; 180: spectroscopic unit: 185: A/D converter; 190: CPU, 195: memory; 200: USB; 220: personal computer; 230: power source; 240, 340: display portion; 300: portable spectroradiometer; 360: input switch; 410: glass dome; 420: diffuser

### DETAILED DESCRIPTION OF THE INVENTION

Embodiments of the present invention are described with reference to the drawings. The following embodiments are examples for explaining the present invention, and thus are not to limit the present invention thereto. The present invention can be implemented in various forms without departing from the scope of the invention.

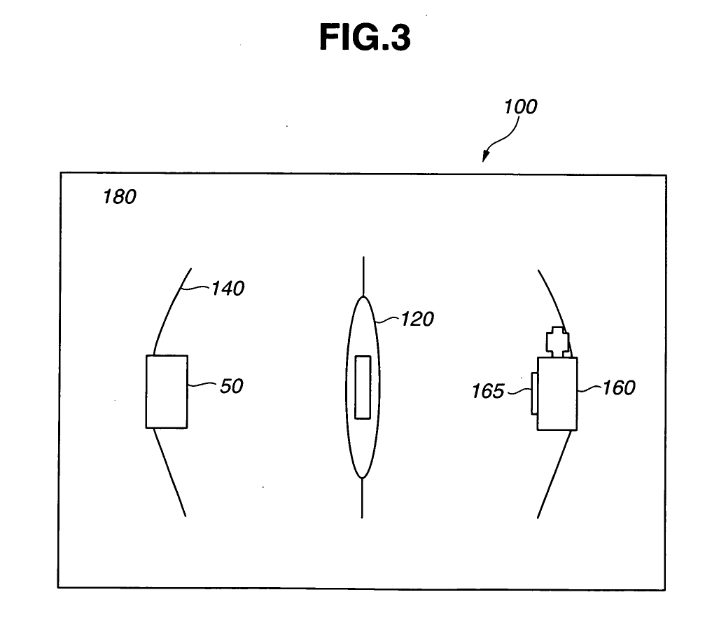

FIG. 3 shows a schematic cross-sectional view of the weathering test apparatus system according to the first aspect of the present invention, in which the weathering test apparatus system comprises the weathering test apparatus and the spectroradiometer having the multi-wavelength resolution function for the weathering test apparatus. The weathering test apparatus 100 shown in FIG. 3 comprises a weathering test light source 120, a basket 140 on which a material to be tested 50 is placed in a position across from the light source 120. Specific examples of the light source 120, but are not limited to, include a xenon lamp, an iodine lamp and the like that have been used conventionally.

It should be noted that the weathering test apparatus system 100 shown in FIG. 3 comprises a configuration in which the material to be tested 50 is disposed inside a constant-temperature bath 180 which is used in acceleration of deterioration of the material to be tested. A spectroradiometer 160, which is used in the constant-temperature bath 180, preferably employs a heat-insulated and hermetically-sealed structure in order to have durability. In order to have such structure, an exterior of the spectroradiometer 160 is made of stainless or fiber reinforced plastic, but the materials configuring the spectrometer 160 are not limited to the above materials. Furthermore, in order to prevent the moisture inside the constant-temperature bath 180 from being mixed into the spectroradiometer, it is desired that the spectroradiometer have the sealed structure. In addition, in order to prevent the temperature inside the constant-temperature bath 180 from being raised, it is preferred that the spectroradiometer being covered with an insulating material in which urethane foam, asbestos or the like is used.

The system 100 further comprises the spectroradiometer 160 which monitors quantity of light of the light source 120. This spectroradiometer 160 comprises an entrance window 165 for receiving light from the light source. By means of the entrance window 165, it is possible to guide a fixed quantity of light from the light source into the spectroradiometer. Specific examples of the spectroradiometer 160 include,.but are not limited to, a photodiode array and the like capable of monitoring multiple wavelengths simultaneously.

It should be noted in FIG. 3 that although the spectroradiometer 160 and the basket 140 for mounting the material to be tested are placed across from each other with the light source 120 therebetween, they do not have to be placed across from each other, thus the spectroradiometer 160 may be disposed in the vicinity of the material to be tested.

In the weathering test apparatus system 100 shown in FIG. 3, light from the light source 120 irradiates the material to be tested 50, the spectroradiometer 160 receives the light, and monitoring of the light quantity can be performed simultaneously with irradiation. Monitoring of the light quantity is explained hereinafter.

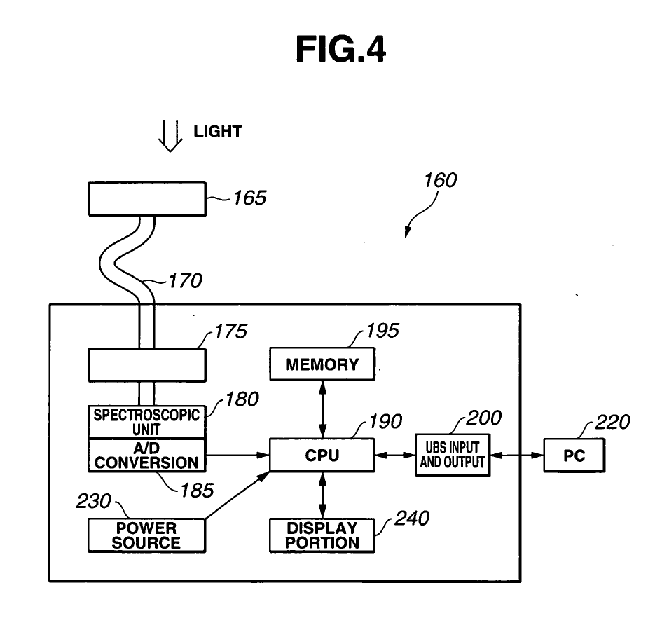

FIG. 4 shows a schematic functional block diagram of an internal structure of the spectroradiometer for use in the present invention. The spectroradiometer 160 used in the present invention receives light from the light source via the entrance window 165, and the received light is guided to a spectroscopic unit 180 having a shutter 175, via a flexible fiber 170. Here, the entrance window 165 is, as described above, configured so as to introduce the light from the light source of the weathering test apparatus to the flexible fiber 170, and a diffuser (not show) for guiding light to the spectroscopic unit is attached to each of an entrance portion and an exit portion (in immediate front of the shutter) of the flexible fiber 170. The diffuser is a member required for separating the colors equally without being affected by the bright spots of the light source. In addition, the entrance window 165 can also be disposed so as to be freely attached to a position in the light source of the weathering test apparatus.

It should be noted that the shutter 175 is disposed between the flexible fiber 170 and the spectroscopic unit 180, and is used to correct dark current of the photodiode array.

It is preferred that the flexible fiber 170 be covered with a metallic flexible corrugated tube in order to prevent the fiber from being broken by external force such as bending.

An example of the spectroradiometer 160 used in the present invention can be a spectroradiometer which comprises a grating and a photodiode array comprising, for example, 256 photodiodes, and executes wavelength resolution of irradiating light. Specific examples of the photodiode array include, but are not limited to, a charge coupled device, which is so-called CCD, a complementary metal oxide semiconductor, which is so-called CMOC and the like.

Thereafter, an output from the photodiode array is subjected to A/D conversion 185, introduced to a CPU 190, and subjected to arithmetic processing. Then, processed spectroscopic data is stored in a memory 195, and read by a personal computer (PC) 220 via a USB 200, according to need. The spectroradiometer 160 used in the present invention carries a large-capacity memory so that it can be used without the PC, and is designed by means of a power source 230 such as a battery. Examples of a power source used in the present invention include, but are not limited to, an AA battery, and, according to need, a nickel hydrogen battery or lithium cell which is rechargeable. Moreover, it is also easy to mount a charging circuit in the spectroradiometer itself.

The data which is measured by the spectroradiometer 160 of the present invention can be displayed by means of the PC. Not only that an integrated value for the wavelengths or each wavelength of the spectral data can be displayed, but also a spectral radiation measurement value can be displayed by means of a graph by installing a display portion 240 on the spectroradiometer 160 itself. Specific examples of the display portion used in the present invention include, but are not limited to, a liquid crystal display and a color liquid crystal display. A plurality of spectral radiation measurement value graphs can be displayed by color or in a superimposed fashion. It should be noted that those skilled in the art can easily understand creating a printed matter of the display portion by means of a printing device, which is not shown in FIG. 4.

The above embodiments have described the spectroradiometer for the weathering test apparatus. Hereinafter another embodiment of the present invention will be described.

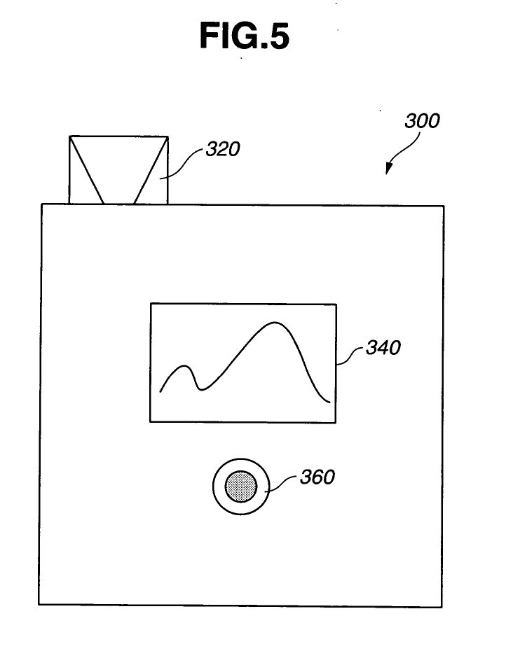

FIG. 5 shows a schematic front view of a portable spectroradiometer which is not limited in the use of the weathering test apparatus and can be used for various purposes, according to the second aspect of the present invention. FIG. 5 shows an example of application to the portable spectroradiometer.

An internal structure of the portable spectroradiometer 300 shown in FIG. 5 is the same as the internal structure shown in FIG. 4, thus the description of FIG. 4 is incorporated. In the spectroradiometer for the weathering test apparatus described above, the entrance window is disposed at an end of the flexible fiber. In the second embodiment of the present invention, however, an entrance window 320 is replaceable. Accordingly, the entrance window can respond to various incidence angels.

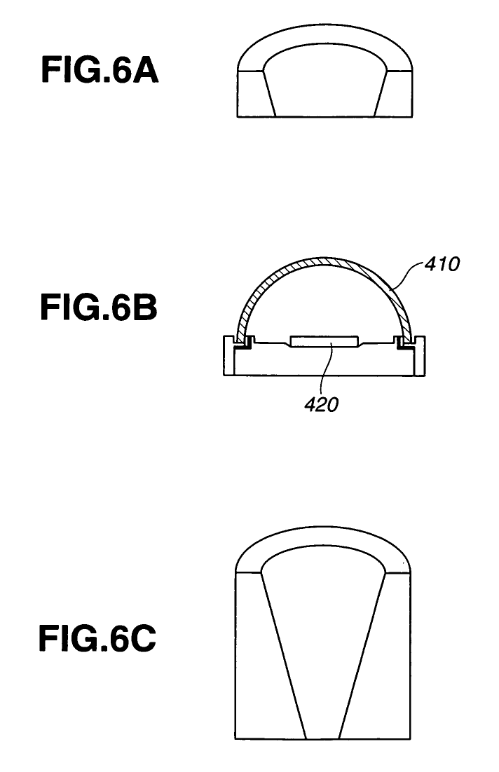

For example, for the purpose of measuring directly light from the sunlight, the incidence angle of the entrance window 320 is preferably as narrow as 5 to 15 degrees (see FIG. 6C). On the other hand, in order to measure the sunlight reflected from a plant or the like, a wide opened angle of 30 to 90 degrees is required (see FIG. 6A). Furthermore, for the purpose of measuring all-weather radiation, it is required that the opened angle be 180 degrees and a glass dome be installed (see FIG. 6B). Here, the entrance window shown in FIG. 6B has a shape suitable in all weather, wherein a semi-circular glass dome 410 and a diffuser 420 inside thereof are provided. It should be noted that although the diffuser is not shown in FIG. 6A and FIG. 6C, light entering from an upper side of each figure is captured through the entrance window, and thereafter passes through the diffuser which is disposed below the entrance window shown in FIG. 6A and FIG. 6C.

It is required that the entrance window 320 be replaceable in order to satisfy these requirements described above and respond to various applications. FIG. 5 shows the portable spectrometer 300 satisfying these requirements, and by providing it with the display portion 340, spectra can be observed. Moreover, an input switch 360 is provided so that the portable spectroradiometer can be used easily. This switch, which is a five-way switch (up, down, left, right and press in) receives a user command. Here, the user command means, for example, parameter setting, starting of measurement and the like.

By means of the portable spectroradiometer 300 having such configuration, the spectroradiometer applied for various purposes can be realized.

We claim:

1. A weathering test apparatus system, comprising:
a weathering test apparatus with a light source; and
a spectroradiometer which monitors deterioration of the light source, wherein the spectroradiometer comprises an entrance window which captures light from the light source, and a spectroscopic unit which is connected optically to the entrance window and has a multi-wavelength resolution function, and the spectroradiometer is disposed inside the weathering test apparatus.

2. The weathering test apparatus system according to claim 1, wherein the spectroscopic unit comprises a photodiode array.

3. The weathering test apparatus system according to claim 1 or 2, wherein the spectroradiometer has a heat-insulated and hermetically-sealed structure so as to be able to withstand a high temperature and a high humidity.

4. The weathering test apparatus system according to any one of claims 1 to 3, wherein the spectroradiometer is battery-powered and further comprises a memory which is able to record therein measured spectral radiation data.

5. A portable spectroradiometer, comprising an entrance window which captures light from the light source, and a spectroscopic unit which is connected optically to the entrance window and has a multi-wavelength resolution function, wherein the entrance window of the spectroradiometer is replaceable.

6. The portable spectroradiometer according to claim 5, wherein the spectroscopic unit comprises a photodiode array.

7. The portable spectroradiometer according to claim 5 or 6, wherein the spectrometer has a heat-insulated and hermetically-sealed structure so as to be able to withstand a high temperature and a high humidity.

8. The portable spectroradiometer according to any one of claims 5 to 7, wherein the spectroradiometer is battery-powered and further comprises memory which can record therein measured spectral radiation data.
